(19) United States
(12) Patent Application Publication
(10) Pub. No.: US 2026/0008879 A1
(43) Pub. Date: Jan. 8, 2026

(54) POLAR ETHYLENE-BASED POLYMER WITH REVERSIBLE CROSSLINKNER

(71) Applicants: Dow Global Technologies LLC, Midland, MI (US); Northwestern University, Evanston, IL (US)

(72) Inventors: John M. Torkelson, Skokie, IL (US); Boran Chen, Evanston, IL (US); Logan Fenimore, Evanston, IL (US); Colin Li Pi Shan, Lake Jackson, TX (US); Hayley A. Brown, Bellaire, TX (US); Evelyn Auyeung, Houston, TX (US); Rachel E.M. Brooner, Midland, MI (US); Stephanie M. Barbon, Midland, MI (US)

(21) Appl. No.: 18/992,452

(22) PCT Filed: Jul. 14, 2023
(86) PCT No.: PCT/US2023/027770

§ 371 Date: Jan. 8, 2025

Related U.S. Application Data
(60) Provisional application No. 63/389,738, filed on Jul. 15, 2022.

(51) Int. Cl. C08F 255/02; C08K 5/14

(52) U.S. Cl. CPC C08F 255/026; C08K 5/14; C08F 2810/20

(57) ABSTRACT

The present disclosure provides a crosslinkable polymer composition. In an embodiment, the crosslinkable polymer composition includes a polar ethylene-based polymer, a free radical initiator, and 2,2,6,6-tetramethyl-4-piperidyl methacrylate disulfide (BiTEMPS methacrylate). The present disclosure provides a crosslinked composition. In an embodiment, the crosslinked composition includes a polar ethylene-based polymer; and 2,2,6,6-tetramethyl-4-piperidyl methacrylate disulfide (BiTEMPS methacrylate).

### BACKGROUND

Crosslinked olefin-based polymers (and crosslinked ethylene-based polymers in particular) are well-known in myriad applications because of their excellent mechanical properties, high heat stability, and outstanding chemical resistance. Unfortunately, crosslinked ethylene-based polymer (also known as thermoset polymer) is unable to be reprocessed and/or recycled due to the presence of the permanent crosslinked network within the ethylene-based polymer. Thus, the use of crosslinked ethylene-based polymer carries concomitant environmental and sustainability concerns.

The ability to reprocess and/or recycle crosslinked ethylene-based polymer has been a long-standing challenge. Consequently, the art recognizes the need for a crosslinked olefin-based polymer (and a crosslinked ethylene-based polymer in particular) that can be reprocessed and/or recycled.

### SUMMARY

The present disclosure provides a crosslinkable polymer composition. In an embodiment, the crosslinkable polymer composition includes a polar ethylene-based polymer, a free radical initiator, and 2,2,6,6-tetramethyl-4-piperidyl methacrylate disulfide (BiTEMPS methacrylate).

The present disclosure provides a crosslinked composition. In an embodiment, the crosslinked composition includes a polar ethylene-based polymer; and 2,2,6,6-tetramethyl-4-piperidyl methacrylate disulfide (BiTEMPS methacrylate).

### Definitions

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes subranges from 1 to 2; from 2 to 6; from 5 to 7; from 3 to 7; from 5 to 6; etc.).

Unless stated to the contrary, implicit from the context, or customary in the art, all parts and percentages are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An “ethylene-based polymer” is a polymer that contains more than 50 mole percent polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations.

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure

An “olefin-based polymer,” or “polyolefin,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

### Test Methods

Density is measured in accordance with ASTM D792 with results reported in g/cc at 25° C.

Differential scanning calorimetry (DSC) is conducted using a Mettler Toledo DSC822e differential scanning calorimeter to measure thermal properties including peak and endpoint melting temperatures and crystallinities of the virgin polymers and crosslinked compositions (network polymers). The network materials tested for most polymers are as-synthesized materials before compression molding. A 10° C./min heating rate and a −40° C./min cooling rate were adapted for all measurements in a temperature range of −60° C. to 160° C.

Dynamic mechanical analysis (DMA). DMA experiments are conducted using a TA Instruments RSA-G2 Solid Analyzer to measure the storage modulus (E′), loss modulus (E″), and damping ratio (tan δ) of networks as a function of temperature and recycling under a nitrogen atmosphere. DMA is operated in tension mode at a frequency of 1 Hz with a 0.03% oscillatory strain. Data is collected from room temperature to 160° C. with a heating rate of 3° C./minute.

Melt index (MI or 12) (for ethylene-based polymers) is measured in accordance with ASTM D 1238, Condition 190° C./2.16 kg with results reported in grams per 10 minutes (g/10 min).

### DETAILED DESCRIPTION

The present disclosure provides a crosslinkable polymer composition. In an embodiment, the crosslinkable polymer composition includes a polar ethylene-based polymer, a free radical initiator, and 2,2,6,6-tetramethyl-4-piperidyl methacrylate disulfide (BiTEMPS methacrylate).

### A. Polar Ethylene-Based Polymer

The crosslinkable polymer composition includes a polar ethylene-based polymer. A “polar ethylene-based polymer,” as used herein, is an ethylene-based polymer composed of (i) ethylene monomer, (ii) a comonomer that contains a heteroatom, and (iii) an optional termonomer (that may or may not contain a heteroatom). Stated differently, the polar ethylene-based polymer is not a hydrocarbon. The polar ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. Nonlimiting examples of comonomers with a heteroatom include carbon monoxide, carboxylic acids, esters, alkyl acrylates having 1 to 30 carbon atoms, methacrylate esters having 1 to 30 carbon atoms, vinyl siloxanes having 1 to 16 carbon atoms and halogens. Nonlimiting examples of suitable polar ethylene-based polymer include ethylene/carboxylic acid copolymer and metal-salt partially neutralized ionomers derived thereof, ethylene/acrylic acid copolymer (EAA), ethylene/methacrylic acid copolymer (EMAA), ethylene/vinyl(trimethoxy) silane copolymer (EVTMS), ethylene/vinyl acetate copolymer (EVA), ethylene/methyl acrylate (EMA), ethylene/ethyl acrylate copolymer (EEA), ethylene/butyl acrylate copolymer (EBA), ethylene/carbon monoxide (ECO), ethylene/glycidyl methacrylate (E/GMA), ethylene/methyl methacrylate copolymer, ethylene/butyl methacrylate copolymer, ethylene/stearylacrylate copolymer, ethylene/stearylmethacrylate copolymer, ethylene/octylacrylate copolymer, ethylene/2-ethylhexylacrylate copolymer, ethylene/dodecylacrylate copolymer, polyvinyldichloride (PVCD), ethylene/maleic anhydride copolymer (EMAH), polyvinylchloride (PVC), and combinations thereof. Additional nonlimiting terpolymer examples include ethylene/carboxylic acid/acrylate terpolymers and metal-salt partially neutralized ionomers derived thereof, ethylene/methyl acrylate/vinyl(trimethoxy) silane terpolymer copolymer (EMAVTMS), ethylene/ethyl acrylate/vinyl(trimethoxy) silane terpolymer copolymer (EEAVTMS), ethylene/butyl acrylate/vinyl(trimethoxy) silane terpolymer copolymer (EBAVTMS), ethylene/methyl (EMAGMA) ethylene/butyl acrylate/glycidyl methacrylate acrylate/glycidyl methacrylate (EBAGMA), ethylene/vinyl acetate/maleic anhydride terpolymer (EEAMAH), ethylene ethyl acrylate/maleic anhydride (EEAMAH) terpolymer, and combinations thereof.

In an embodiment, the polar ethylene-based polymer is an ethylene/vinyl acetate copolymer.

### B. Free Radical Initiator

The crosslinkable composition includes a free radical initiator. In an embodiment, the free radical initiator is an organic peroxide. Nonlimiting examples of suitable organic peroxide include bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1-dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(α-t-butyl-peroxyisopropyl)benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; di(isopropylcumyl) peroxide; dicumyl peroxide, and combinations thereof.

In an embodiment the free radical initiator is dicumyl peroxide.

### C. BiTEMPS Methacrylate Disulfide

The crosslinkable polymer composition includes 2,2,6,6-tetramethyl-4-piperidyl methacrylate, interchangeably referred to as “BiTEMPS methacrylate,” or “BiTEMPS” or “BiT.” BiTEMPS methacrylate disulfide has the Structure 1 below.

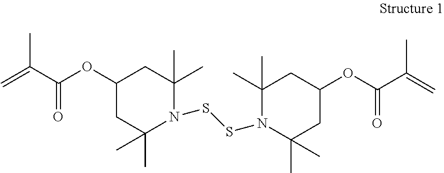 [SMILES: C=C(C)C(=O)OC1CC(C)(C)N(SSN2C(C)(C)CC(OC(=O)C(=C)C)CC2(C)C)C(C)(C)C1]

In an embodiment, the crosslinkable polymer composition includes
from 70 wt % to 98.5 wt %, or from 77 wt % to 98.5 wt % of the polar ethylene-based polymer;
from 0.5 wt % to 10 wt %, or from 0.5 wt % to 5 wt %, or from 0.5 wt % to 3.0 wt % or from 0.5 wt % to 1.5 wt %, or from 1.5 wt % to 3.0 wt % free radical initiator that is an organic peroxide (such as dicumyl peroxide for example); and
from 1 wt % to 20 wt %, or from 1 wt % to 15 wt %, or from 3 wt % to 20 wt %, or from 3 wt % to 10 wt % BiTEMPS methacrylate disulfide. It is understood that the aggregate of the polar ethylene-based polymer, the free radical initiator, and the BiTEMPS methacrylate disulfide (and optional additives) amounts to 100 wt % of the crosslinkable polymer composition.

The present disclosure provides a crosslinked composition. The crosslinkable polymer composition is melt blended at a temperature from 100° C. to 250° C., or from 120° C. to 200° C., or from 120° C. to 180° C., or from 120° C. to 160° C. to trigger the crosslinking reaction and form the crosslinked composition. In an embodiment, the crosslinked composition includes a polar ethylene-based polymer and 2,2,6,6-tetramethyl-4-piperidyl methacrylate disulfide (BiTEMPS methacrylate). The crosslinked composition contains disulfide linkages formed from the BiTEMPS methacrylate by way of the crosslinking reaction, the disulfide linkages having the Structure 2 below.

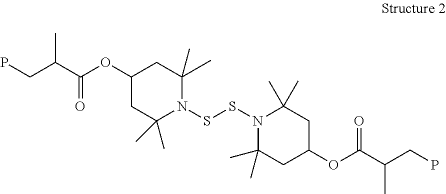

The term (and structure) “P” in Structure 2 above refers to the chain of polymerized ethylene (and comonomer with heteroatom) for the polar ethylene-based polymer. The polar ethylene-based polymer of the crosslinked composition can be any polar ethylene-based polymer with a MI from 0.1 g/10 min to 100 g/10 min as previously disclosed herein. Nonlimiting examples of suitable polar ethylene-based polymer include ethylene/carboxylic acid copolymer and metal-salt partially neutralized ionomers derived thereof, ethylene/acrylic acid copolymer (EAA), ethylene/methacrylic acid copolymer (EMAA), ethylene/vinyl(trimethoxy) silane copolymer (EVTMS), ethylene/vinyl acetate copolymer (EVA), ethylene/methyl acrylate (EMA), ethylene/ethyl acrylate copolymer (EEA), ethylene/butyl acrylate copolymer (EBA), ethylene/carbon monoxide (ECO), ethylene/glycidyl methacrylate (E/GMA), ethylene/methyl methacrylate copolymer, ethylene/butyl methacrylate copolymer, ethylene/stearylacrylate copolymer, ethylene/stearylmethacrylate copolymer, ethylene/octylacrylate copolymer, ethylene/2-ethylhexylacrylate copolymer, ethylene/dodecylacrylate copolymer, polyvinyldichloride (PVCD), ethylene/maleic anhydride copolymer (EMAH), polyvinylchloride (PVC), and combinations thereof. Additional nonlimiting terpolymer examples include ethylene/carboxylic acid/acrylate terpolymers and metal-salt partially neutralized ionomers derived thereof, ethylene/methyl acrylate/vinyl(trimethoxy) silane terpolymer copolymer (EMAVTMS), ethylene/ethyl acrylate/vinyl(trimethoxy) silane terpolymer copolymer (EEAVTMS), ethylene/butyl acrylate/vinyl(trimethoxy) silane terpolymer copolymer (EBAVTMS), ethylene/methyl acrylate/glycidyl methacrylate (EMAGMA) ethylene/butyl acrylate/glycidyl methacrylate (EBAGMA), ethylene/vinyl acetate/maleic anhydride terpolymer (EEAMAH), ethylene ethyl acrylate/maleic anhydride (EEAMAH) terpolymer, and combinations thereof.

In an embodiment, the polar ethylene-based polymer is a virgin polar ethylene-based polymer. A “virgin polar ethylene-based polymer,” as used herein, is a polar ethylene-based polymer that has not been subjected to a crosslinking reaction. In other words, the term “virgin polar ethylene-based polymer” refers to the polar ethylene-based polymer that is present in the crosslinked composition prior to the polar ethylene-based polymer being crosslinked with the BiTEMPS methacrylate. The virgin polar ethylene-based polymer is the polar ethylene-based polymer prior to crosslinking, the crosslinked composition containing the same polar ethylene-based polymer that was virgin, but is now crosslinked with BiTEMPS methacrylate. In this way, the virgin polar ethylene-based polymer serves as a baseline to evaluate the properties of the crosslinked composition. The crosslinked composition has
(i) a storage modulus value, E′, at 140° C. that is greater than the storage modulus value, E′, for the virgin polar ethylene-based polymer at 140° C.;
(ii) a tan delta value at 60° C. that is less than the tan delta value of the virgin polar ethylene-based polymer at 60° C.; and
(iii) a tan delta value at 140° C. that is less than the tan delta value of the virgin polar ethylene-based polymer at 140° C.

In an embodiment, the crosslinked composition includes from 80 wt % to 97 wt % of the polar ethylene-based polymer and from 3 wt % to 20 wt % BiTEMPS methacrylate, the aggregate of the polar ethylene-based polymer and the BiTEMPS methacrylate (and optional additives) amounting to 100 wt % of the crosslinked composition. The crosslinked composition has
(i) a storage modulus value, E′, at 60° C. greater than 1 MPa;
(ii) a storage modulus value, E′, at 140° C. greater than 0.1 MPa;
(iii) a tan delta value at 60° C. less than 0.17; and
(iv) a tan delta value at 140° C. less than 0.62.

### D. Blend Component

In an embodiment, the crosslinkable composition and/or the crosslinked composition includes a blend component. Nonlimiting examples of suitable blend component include ethylene vinyl acetate (EVA), polyolefins (e.g., polyethylene other than the polar ethylene-based polymer crosslinked with BiTEMPS methacrylate and polypropylene), polymers (e.g., polystyrene, ABS, SBS and the like) and combinations thereof. Non-limiting examples of suitable polyolefins include polyethylene; polypropylene; polybutylene (e.g., polybutene-1); polypentene-1; polyhexene-1; polyoctene-1; polydecene-1; poly-3-methylbutene-1; poly-4-methylpentene-l; polyisoprene; polybutadiene; poly-1,5-hexadiene; interpolymers derived from olefins; interpolymers derived from olefins and other polymers such as polyvinyl chloride, polystyrene, polyurethane, and the like; and mixtures thereof.

In an embodiment, the polyolefin is a homopolymer such as polyethylene, polypropylene, polybutylene, polypentene-1, poly-3-methylbutene-1, poly-4-methylpentene-1, polyisoprene, polybutadiene, poly-1,5-hexadiene, polyhexene-1, polyoctene-1 and polydecene-1.

Nonlimiting examples of suitable polyethylene as blend component (other than the polar ethylene-based polymer that is crosslinked with BITEMPS methacrylate) include ultra low density polyethylene (ULDPE), linear low density polyethylene (LLDPE), low density polyethylene (LDPE), medium density polyethylene (MDPE), high density polyethylene (HDPE), high molecular weight high density polyethylene (HMW-HDPE), ultra high molecular weight polyethylene (UHMW-PE) and combinations thereof. Nonlimiting examples of polypropylene include low density polypropylene (LDPP), high density polypropylene (HDPP), high-melt strength polypropylene (HMS-PP) and combination thereof. In an embodiment, the blend component is a high-melt-strength polypropylene (HMS-PP), a low density polyethylene (LDPE) or a combination thereof.

### E. Additives

The crosslinkable composition and/or the crosslinked composition may contain one or more optional additives. Nonlimiting examples of suitable additives include grafting initiators, cross-linking catalysts, blowing agent, blowing agent activators (e.g., zinc oxide, zinc stearate and the like), coagents (e.g., triallyl cyanurate), plasticizers, processing oils, processing aids, carbon black, colorants or pigments, stability control agents, nucleating agents, fillers, antioxidants, acid scavengers, ultraviolet (UV) stabilizers, flame retardants, lubricants, processing aids, extrusion aids, and combinations thereof. When present, the total amount of additive can be from greater than 0 to 80%, or from 0.001% to 70%, or from 0.01% to 60%, or from 0.1% to 50%, or from 0.1% to 40%, or from 0.1% to 20%, or from 0.1% to 10%, or from 0.1% to 5% of the total weight of the composition.

In an embodiment, the crosslinkable composition and/or the crosslinked composition includes an antioxidant. Non-limiting examples of suitable antioxidants include aromatic or hindered amines such as alkyl diphenylamines, phenyl-α-naphthylamine, alkyl or aralkyl substituted phenyl-α-naphthylamine, alkylated p-phenylene diamines, tetramethyl-diaminodiphenylamine and the like; phenols such as 2,6-di-t-butyl-4-methylphenol; 1,3,5-trimethyl-2,4,6-tris(3′,5,-di-t-butyl-4,-hydroxybenzyl)benzene; tetrakis[(methylene(3,5-di-t-butyl-4-hydroxyhydrocinnamate)]methane (e.g., IRGANOX™ 1010, from Ciba Geigy, New York); acryloyl modified phenols; octadecyl-3,5-di-t-butyl-4-hydroxycinnamate (e.g., IRGANOX™ 1076, commercially available from Ciba Geigy); phosphites and phosphonites; hydroxylamines; benzofuranone derivatives; and combinations thereof. Where used, the amount of the antioxidant in the composition can be from greater than 0 to 5 wt %, or from 0.0001 to 2.5 wt %, or from 0.001 to 1 wt %, or from 0.001 to 0.5 wt % of the total weight of the composition.

In an embodiment, the crosslinkable composition and/or the crosslinked composition includes a UV stabilizer. Non-limiting examples of suitable UV stabilizers include benzophenones, benzotriazoles, aryl esters, oxanilides, acrylic esters, formamidines, carbon black, hindered amines, nickel quenchers, hindered amines, phenolic antioxidants, metallic salts, zinc compounds and combinations thereof. Where used, the amount of the UV stabilizer can be from greater than 0 to 5 wt %, or from 0.01 wt % to 3 wt %, or from 0.1 wt % to 2 wt %, or from 0.1 wt % to 1 wt % of the total weight of the composition.

In an embodiment, the crosslinkable composition and/or the crosslinked composition includes a colorant or a pigment. Non-limiting examples of suitable colorants or pigments include inorganic pigments such as metal oxides such as iron oxide, zinc oxide, and titanium dioxide, mixed metal oxides, carbon black, organic pigments such as anthraquinones, anthanthrones, azo and monoazo compounds, arylamides, benzimidazolones, BONA lakes, diketopyrrolo-pyrroles, dioxazines, disazo compounds, diarylide compounds, flavanthrones, indanthrones, isoindolinones, isoindolines, metal complexes, monoazo salts, naphthols, b-naphthols, naphthol AS, naphthol lakes, perylenes, perinones, phthalocyanines, pyranthrones, quinacridones, andquinophthalones, and combinations thereof. Where used, the amount of the colorant or pigment in the composition can be from greater than 0 to 10 wt %, or from 0.1 wt % to 5 wt %, or from 0.25 wt % to 2 wt % of the total weight of the composition.

In an embodiment, the crosslinkable composition and/or the crosslinked composition includes a filler. Nonlimiting examples of suitable fillers include talc, calcium carbonate, chalk, calcium sulfate, clay, kaolin, silica, glass, fumed silica, mica, wollastonite, feldspar, aluminum silicate, calcium silicate, alumina, hydrated alumina such as alumina trihydrate, glass microsphere, ceramic microsphere, thermoplastic microsphere, barite, wood flour, glass fibers, carbon fibers, marble dust, cement dust, magnesium oxide, magnesium hydroxide, antimony oxide, zinc oxide, barium sulfate, titaniumdioxide, titanates and combinations thereof.

In an embodiment, the filler is barium sulfate, talc, calcium carbonate, silica, glass, glass fiber, alumina, titanium dioxide, or a mixture thereof. In a further embodiment, the filler is talc, calcium carbonate, barium sulfate, glass fiber or a mixture thereof. Where used, the amount of the filler in the composition can be from greater than 0 to 80 wt %, or from 0.1 to 60 wt %, or from 0.5 to 40 wt %, or from 1 to 30 wt %, or from 10 to 40 wt % of the total weight of the composition.

In an embodiment, the crosslinkable composition and/or the crosslinked composition includes a lubricant. Nonlimiting examples of suitable lubricants include fatty alcohols and their dicarboxylic acid esters, fatty acid esters of short chain alcohols, fatty acids, fatty acid amides, metal soaps, oligomeric fatty acid esters, fatty acid esters of long-chain alcohols, montan waxes, polyethylene waxes, polypropylene waxes, natural and synthetic paraffin waxes, fluoropolymers and combinations thereof. Where used, the amount of the lubricant in the composition can be from greater than 0 wt % to 5 wt %, or from 0.1 to 4 wt %, or from 0.1 wt % to 3 wt % of the total weight of the composition.

In an embodiment, the crosslinkable composition and/or the crosslinked composition includes an antistatic agent. Non-limiting examples of suitable antistatic agents include conductive fillers (e.g., carbon black, metal particles and other conductive particles), fatty acid esters (e.g., glycerol monostearate), ethoxylated alkylamines, diethanolamides, ethoxylated alcohols, alkylsulfonates, alkylphosphates, quaternary ammonium salts, alkylbetaines and combinations thereof. Where used, the amount of the antistatic agent in the composition can be from greater than 0 wt % to 5 wt %, or from 0.01 to 3 wt %, or from 0.1 to 2 wt % of the total weight of the composition.

In an embodiment, the crosslinkable composition and/or the crosslinked composition includes a blowing agent. A “blowing agent” is a substance that is capable of producing a cellular structure in the composition via a foaming process. The blowing agent is used for foaming the crosslinked composition. Nonlimiting examples of suitable blowing agent include an inorganic physical blowing agent, such as air, argon, nitrogen, carbon dioxide, argon, helium, oxygen, and neon, and an organic physical blowing agent, such as an aliphatic hydrocarbon, e.g., propane, n-butane, isobutane, n-pentane, isopentane, and n-hexane, an alicyclic hydrocarbon, e.g., cyclohexane and cyclopentane, a halogenated hydrocarbon, e.g., chlorofluoromethane, trifluoromethane, 1,1-difluoroethane, 1,1,1,2-tetrafluoroethane, methyl chloride, ethyl chloride, and methylene chloride, and a dialkyl ether, e.g., dimethyl ether, diethyl ether, and methyl ethyl ether.

Non-limiting examples of suitable organic blowing agents include aliphatic hydrocarbons having 1-6 carbon atoms, aliphatic alcohols having 1-3 carbon atoms, and fully and partially halogenated aliphatic hydrocarbons having 1-4 carbon atoms. Non-limiting examples of suitable aliphatic hydrocarbons include methane, ethane, propane, n-butane, isobutane, n-pentane, isopentane, neopentane, and the like. Non-limiting examples of suitable aliphatic alcohols include methanol, ethanol, n-propanol, and isopropanol. Non-limiting examples of suitable fully and partially halogenated aliphatic hydrocarbons include fluorocarbons, chlorocarbons, and chlorofluorocarbons. Non-limiting examples of suitable fluorocarbons include methyl fluoride, perfluoromethane, ethyl fluoride, 1,1-difluoroethane (HFC152a), 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Non-limiting examples of suitable partially halogenated chlorocarbons and chlorofluorocarbons include methyl chloride, methylene chloride, ethyl chloride, 1,1,1-trichloroethane, 1,1-dichloro-1-fluoroethane (HCFC-141b), I-chloro-I,Idifluoroethane (HCFC-142b), I,I-dichloro-2,2,2-trifluoroethane (HCFC-123) and I-chloro-I,2,2,2-tetrafluoroethane (HCFC-124). Non-limiting chlorofluorocarbons include examples of suitable fully halogenated trichloromonofluoromethane (OPOI 1), dichlorodifluoromethane (CFO-12), trichlorotrifluoroethane (CFO-113), 1,1,1-trifluoroethane, pentafluoroethane, dichlorotetrafluoroethane (CFO-114), chloroheptafluoropropane, and dichlorohexafluoropropane. Non-limiting examples of suitable chemical blowing agents include azodicarbonamide, azodiisobutyro-nitrile, benezenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, and trihydrazino triazine.

BiTEMPS methacrylate is a “dynamic crosslinker.” The dynamic crosslinker BiTEMPS methacrylate enables formation of a crosslinked network with the polar ethylene-based polymer by way of disulfide linkages between the chains of the polar ethylene-based polymer (in the presence of the free radical initiator) to form the crosslinked polar ethylene-based polymer composition. The crosslinking is dynamic because the disulfide linkages may be broken, allowing for chain mobility and exchange when the crosslinked polar ethylene-based polymer composition is subjected to a “reprocessing temperature,” the reprocessing temperature being a temperature from 100° C. to 250° C., or from 120° C. to 200° C., or from 120° C. to 180° C., or from 120° C. to 160° C. At the reprocessing temperature, the disulfide linkages in the crosslinked polar ethylene-based polymer composition are broken, forming a re-processable polar ethylene-based polymer composition. Cooling the re-processable polar ethylene-based composition below the reprocessing temperature forms a re-crosslinked polar ethylene-based polymer composition.

The dynamic crosslinker BiTEMPS methacrylate enables a cyclic “reprocessing” for fabrication of new polymeric articles. When the crosslinked polar ethylene-based polymer composition is heated to the reprocessing temperature, the disulfide linkages break, or otherwise cleave, enabling the previously-crosslinked polar ethylene-based polymer composition to flow at the reprocessing temperature, forming “a re-processable polar ethylene-based polymer composition.” Heating to the reprocessing temperature enables link breaking and polymer chain flow, allowing the polar ethylene-based composition to be reshaped readily. At the reprocessing temperature, the re-processable polar ethylene-based polymer composition is no longer crosslinked, but rather is flowable, enabling shaping and/or fabrication of the now flowable re-processable polar ethylene-based polymer composition (with BiTEMPS methacrylate) into a new pre-form or article. Upon cooling to below the “reprocessing temperature,” the disulfide linkages form again, the network is re-established, and the re-crosslinked polar ethylene-based compositions is formed in the new article configuration with a return to the high viscosity (no flow at room temperature) and resistance to mechanical deformation indicative of the crosslinked network. When the newly-formed article of the re-processable polar ethylene-based polymer composition is cooled below the reprocessing temperature, the disulfide linkages in the re-processable polar ethylene-based polymer composition are re-established, and the polar ethylene-based polymer (with BiTEMPS methacrylate) becomes a re-crosslinked polar ethylene-based polymer composition in the shape of the newly-fabricated article. Below the reprocessing temperature, the network disulfide linkages are stable, and the re-crosslinked polar ethylene-based polymer composition exhibits the high viscosity and resistance to mechanical deformation indicative of a crosslinked network. This cycle of crosslink/re-process/re-crosslink and fabrication into a new article can be repeated.

Bounded by no particular theory, the number of “reprocessing” cycles that are possible with the present crosslinked polar ethylene-based composition (before competitive thermal and oxidative permanent crosslinking occurs and prevents further reprocessing), can be determined by calculating the ratio of the melt viscosity of the crosslinked polar ethylene-based polymer composition before and after a reprocessing cycle. For the crosslinked polar ethylene-based polymer composition to be re-processable, the ratio of the Mooney viscosity after reprocessing to the Mooney viscosity before reprocessing is from 0.5 to 5, or from 0.7 to 3 or from 0.9 to 2 or from 0.95 to 1.2.

Other metrics for monitoring the number of “reprocessing” cycles that are possible with the BiTEMPS methacrylate dynamic crosslinker before competitive oxidative permanent crosslinking occurs include visual observation. Formed film that is mechanically deformed is heated to the reprocessing temperature, and is visually inspected to determine whether the mechanically deformed film heals to form a stable film. This metric of re-processability is noted in Table 2 below.

The present disclosure provides a process. In an embodiment, the process includes heating a first article to a reprocessing temperature. The first article is composed of a crosslinked polar ethylene-based polymer composition comprising (i) an ethylene-based polymer; and (ii) 2,2,6,6-tetramethyl-4-piperidyl methacrylate disulfide (BiTEMPS methacrylate). The process includes forming, at the reprocessing temperature, the first article into a re-processable polar ethylene-based polymer composition. The process includes shaping, at the reprocessing temperature, the re-processable polar ethylene-based composition into a re-processed pre-form. The process includes cooling the re-processed pre-form to below the reprocessing temperature and forming a second article composed of a re-crosslinked polar ethylene-based polymer composition composed of (i) the polar ethylene-based polymer and (ii) the BiTEMPS methacrylate, the second article different than the first article.

In an embodiment, the shaping step is a procedure selected from the group consisting of injection molding, extrusion molding, thermoforming, slushmolding, over molding, insert molding, blow molding, cast molding, tentering, and combinations thereof.

Nonlimiting examples of suitable articles (first article and second article) for the present crosslinked/re-crosslinked polar ethylene-based polymer (with BiTEMPS methacrylate) composition include elastic film; elastic fiber; soft touch good, such as tooth brush handles and appliance handles; gaskets and profiles; adhesives (including hot melt adhesives and pressure sensitive adhesives); footwear (including shoe soles and shoe liners); auto interior parts and profiles; foam articles (both open cell foam and closed cell foam); impact modifiers for other thermoplastic polymers such as high density polyethylene, isotactic polypropylene, or other olefin polymers; coated fabrics; hoses; tubing; weather stripping; cap liners; flooring; and combinations thereof.

By way of example, and not limitation, some embodiments of the present disclosure will now be described in detail in the following examples.

### 1. Materials

Materials used in the comparative samples (CS) and inventive examples (IE) are provided in Table 1 below.

TABLE 1

| Name | Structure/properties | Source |
|---|---|---|
| Polymer 1 ELVAX ™ 260 | Ethylene/vinyl acetate copolymer - 28 wt % vinyl acetate | Dow Inc. |
| | comonomer | |
| | d - 0.951 g/cc, MI - 6.0 | |
| BiTEMPS methacrylate | 2,2,6,6-tetramethyl-4-piperidyl methacrylate disulfide | Custom |
| Crosslinker (“BiT”) | (Structure 1) C₂₆H₄₄N₂O₄S₂ | synthesis |
| Dicumyl Peroxide (“DCP”) | C₁₈H₂₂O₂ | Sigma-Aldrich |
| Radical initiator | | |

### 1. Synthesis of BiTEMPS Methacrylate

To synthesize BiTEMPS methacrylate, 2,2,6,6-tetramethyl-4-piperidyl methacrylate (8.78 g, 39.0 mmol, supplied by TCI America) is first dissolved in anhydrous petroleum ether (˜90 mL, supplied by Sigma-Aldrich, dried over molecular sieves for 48 hr before use) and cooled to −70° C. in a dry ice/acetone bath. Afterward, sulfur monochloride (1.30 g, 9.7 mmol, supplied by Sigma-Aldrich) is dissolved in anhydrous petroleum ether (˜1.25 mL) and added dropwise to the reaction vessel over the course of 30 minutes. The solution is stirred at −70° C. for an additional 30 minutes and at room temperature for 15 minutes. Next, BiTEMPS methacrylate is precipitated out by pouring the reaction solution into copious distilled water and stirring at room temperature overnight. The precipitates are collected, vacuum-filtered, and vacuum-dried at 60° C. for 48 hr to obtain BiTEMPS methacrylate, shown as Structure 1 below.

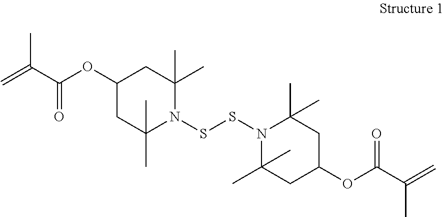

### 2. Preparation of Crosslinked Compositions

Appropriate masses of starting materials including polymer pellets (polar ethylene-based polymer), crosslinker (BiTEMPS methacrylate), and radical initiator (DCP) are massed separately on an analytical balance (typically, 2 g of polymer, 0.1 g of crosslinker, and 0.02 g of radical initiator). Prior to synthesis, the cup of a Dynisco (formerly Atlas) Laboratory Mixing Molder (LMM) is flushed of impurities by loading the polymer of interest, heating to above its melt transition, and mixing for 3-5 minutes. After removing the polymer debris from flushing, the massed polymer pellets and the powder mixture of crosslinker and radical initiator are added via spatula into the cup. The starting materials are added in doses such that they are evenly distributed throughout the cup prior to mixing. Additionally, three steel balls (˜5 mm diameter) are added evenly to the cup to emulate extrusion processes during melt-state mixing. Next, the temperature of the LMM is increased above the melt transition of the polymer, and the starting materials are mixed at this temperature at 120 rpm (maximum rotational speed) for 3-5 minutes to ensure homogenization of the ingredients in the melt state while minimizing radical initiation. For Polymer 1, this mixing temperature is 100° C. After this homogenization, the temperature of the LMM is ramped to 160° C. to commence radical initiation and crosslinker grafting processes. Mixing occurs at this temperature for approximately 20 minutes. During mixing, the rotor of the LMM is manually cycled upwards and downwards periodically to facilitate homogenization of the blend. After mixing for 20 minutes, mixing is ceased, and the crosslinked polymer blend is removed from the cup via spatula.

Crosslinked compositions (network blends) are cut into pieces and compression molded into films with dimensions 50 mm in length, 25 mm in width, and 0.65 mm thick in a PHI press (Model 0230C-X1) at 160° C. and 8 MPa for 30 minutes to obtain 1^{st}-molded samples. Films are cut into millimeter-sized pieces and compression molded at the same conditions to obtain 2^{nd}-molded samples, and this procedure is repeated again to obtain 3^{rd}-molded samples. Strips are cut from each sample film for dynamic mechanical analysis (DMA).

### 3. Polymer 1

Table 2 is provided below.

| | | IE1 |
|---|---|---|
| | | ELVAX ™ |
| Tested Property | Polymer Mold | 260 |
| BiT/DCP | | 10/2 |
| (wt %) | | |
| E′ at 60° C. (MPa) | Virgin | 3.23 |
| ~E′ of Virgin Polymer | 1^{st} Mold | 2.69 |
| ~≥E′ of 1^{st} Mold | 2^{nd} Mold | 2.61 |
| ~≥E′ of 1^{st} Mold | 3^{rd} Mold | 2.67 |
| E′ at 140° C. (MPa) | Virgin | 0.001 |
| ~E′ of Virgin Polymer | 1^{st} Mold | 0.28 |
| ~≥E′ of 1^{st} Mold | 2^{nd} Mold | 0.26 |
| ~≥E′ of 1^{st} Mold | 3^{rd} Mold | 0.26 |
| tan δ at 60° C. | Virgin | 0.14 |
| <tan δ of Virgin Polymer | 1^{st} Mold | 0.14 |
| ~tan δ of 1^{st} Mold | 2^{nd} Mold | 0.13 |
| ~tan δ of 1^{st} Mold | 3^{rd} Mold | 0.13 |
| tan δ at 140° C. | Virgin | N/A |
| <tan δ of Virgin Polymer | 1^{st} Mold | 0.34 |
| ~tan δ of 1^{st} Mold | 2^{nd} Mold | 0.37 |
| ~tan δ of 1^{st} Mold | 3^{rd} Mold | 0.37 |
| T_{m, peak} − T_{m, endpoint} (° C.) | Virgin | 70-124 |
| ~<T_{m, peak} − T_{m, endpoint} of Virgin Polymer | As-synthesized | 67-122 |
| | Network | |
| Crystallinity (%) | Virgin | 32 |
| ~<Crystallinity of Virgin Polymer | As-synthesized | 29 |
| | Network | |

Table 2 exhibits E′ and tan δ at both 60° C. and 140° C. for the IE1 crosslinked composition (network formulation) of Polymer 1. E′ value at 60° C. of the network polymer is equal (on the same order of magnitude) to the E′ value of the respective virgin polymer within experimental uncertainty. Depending on the change in crystallinity after dynamic crosslinking and processing compared to the virgin polymer, E′ value at this temperature may be slightly smaller (decrease in crystallinity will decrease E′ below the melt transition despite enhancement from crosslinking) or slightly larger (crystallinity is marginally affected and crosslinking enhances E′). Successive molds at this temperature for the IE1 crosslinked composition with Polymer 1 exhibits an E′ value approximately equal (on the same order of magnitude) to the E′ value of the respective virgin polymer and 1^{st}-molded samples within experimental uncertainty.

At 140° C., E′ value of the IE1 crosslinked composition (network polymer) is larger than the E′ value of respective virgin Polymer 1, as the virgin Polymer 1 does not possess network characteristics that would give large E′ values (>0.1 MPa) above the melt transition. Successive molds at 140° C. for the IE1 Polymer crosslinked composition exhibits E′ values approximately equal (on the same order of magnitude) or slightly larger (from additional crosslink formation during processing) to the E′ values of the 1^{st}-molded samples within experimental uncertainty.

Coinciding with the larger presence of crosslinks in the network materials, tan δ values at both 60° C. and 140° C. are smaller for the IE1 crosslinked composition (network formulation) compared to its respective virgin counterpart Polymer 1. Additionally, these values are maintained for successively molded samples at both temperatures both 60° C. and 140° C. The IE1 crosslinked composition presented in Table 2 demonstrates that Polymer 1 not only gives substantial dynamic network response upon crosslinking (>1 MPa at 60° C. and >0.1 MPa at 140° C.) but also is reprocessable and recovers its E′ and tan δ values after successive compression molding cycles. Comparative samples that are processable do not achieve substantial network responses, and comparative samples that give substantial network responses are unable to be reprocessed and do not recover thermomechanical properties after processing due to the presence of permanent crosslinks rather than sufficient dynamic crosslinks.

Table 2 provides the thermal properties (melting ranges and crystallinities) of the virgin Polymer 1 (comparative sample) and inventive example IE1 crosslinked composition (network formulation) determined by DSC. Reactive crosslinking diminishes the order of the crystal structures formed during cooling post-processing, slightly decreasing the crystallinities as well as decreasing melting peaks and endpoints of the network polymers compared to the virgin counterpart Polymer 1 (the comparative sample).

It is specifically intended that the present disclosure not be limited to the embodiments and illustrations contained herein, but include modified forms of those embodiments including portions of the embodiments and combination of elements of different embodiments as come within the scope of the following claims.

1. A crosslinkable polymer composition comprising:
a polar ethylene-based polymer;
a free radical initiator; and
2,2,6,6-tetramethyl-4-piperidyl methacrylate disulfide (BiTEMPS methacrylate).

2. The crosslinkable polymer composition of claim 1 wherein the polar ethylene-based polymer has a melt index from 0.1 g/10 min to 100 g/10 min.

3. The crosslinkable polymer composition of claim 1 wherein the polar ethylene-based polymer is selected from the group consisting of ethylene/carboxylic acid copolymer, ethylene/acrylic acid copolymer (EAA), ethylene/vinyl acetate copolymer (EVA), ethylene/ethyl acrylate copolymer (EEA), ethylene/butyl acrylate copolymer (EBA), ethylene/methyl methacrylate copolymer, ethylene/butyl methacrylate copolymer, ethylene/stearylacrylate copolymer, ethylene/stearylmethacrylate copolymer, ethylene/octylacrylate copolymer, ethylene/2-ethylhexylacrylate copolymer, ethylene/dodecylacrylate copolymer, polyvinylchloride (PVC), and combinations thereof.

4. The crosslinkable polymer composition of claim 1 wherein the free radical initiator is an organic peroxide.

5. The crosslinkable polymer composition of claim 1 comprising:
from 70 wt % to 98.5 wt % of the polar ethylene-based polymer;
from 0.5 wt % to 10.0 wt % free radical initiator; and
from 1 wt % to 20 wt % BiTEMPS methacrylate.

6. The crosslinkable polymer of claim 1 wherein the free radical initiator is dicumyl peroxide.

7. A crosslinked composition comprising:
a polar ethylene-based polymer; and
2,2,6,6-tetramethyl-4-piperidyl methacrylate disulfide (BiTEMPS methacrylate).

8. The crosslinked composition of claim 7 wherein the crosslinked composition comprises linkages of Structure 2

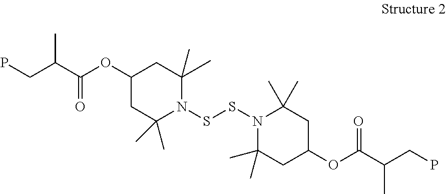

9. The crosslinked composition of claim 7 comprising
from 80 wt % to 99 wt % of a polar ethylene-based polymer having a melt index from 0.1 g/10 min to 100 g/10 min; and
from 20 wt % to 1 wt % of the BiTEMPS methacrylate.

10. The crosslinked composition of claim 7 wherein the polar ethylene-based polymer is selected from the group consisting of ethylene/carboxylic acid copolymer, ethylene/acrylic acid copolymer (EAA), ethylene/vinyl acetate copolymer (EVA), ethylene/ethyl acrylate copolymer (EEA), ethylene/butyl acrylate copolymer (EBA), ethylene/methyl methacrylate copolymer, ethylene/butyl methacrylate copolymer, ethylene/stearylacrylate copolymer, ethylene/stearylmethacrylate copolymer, ethylene/octylacrylate copolymer, ethylene/2-ethylhexylacrylate copolymer, ethylene/dodecylacrylate copolymer, polyvinylchloride (PVC), and combinations thereof.

11. The crosslinked composition of claim 7 wherein
the polar ethylene-based polymer is a virgin polar ethylene-based polymer prior to the crosslinked composition being crosslinked; and
the crosslinked composition has
(i) a storage modulus value, E′, at 140° C. that is greater than the storage modulus value, E′, for the virgin polar ethylene-based polymer at 140° C.;
(ii) a tan delta value at 60° C. that is less than the tan delta value of the virgin polar ethylene-based polymer at 60° C.; and
(iii) a tan delta value at 140° C. that is less than the tan delta value of the virgin polar ethylene-based polymer at 140° C.

12. The crosslinked composition of claim 7 comprising:
from 3 wt % to 20 wt % BiTEMPS methacrylate; and
the crosslinked composition has
(i) storage modulus value, E′, at 60° C. greater than 1 MPa;
(ii) a storage modulus value, E′, at 140° C. greater than 0.1 MPa;
(iii) a tan delta value at 60° C. less than 0.17; and
(iv) a tan delta value at 140° C. less than 0.62.

13. A process comprising:
heating a first article to a reprocessing temperature, the first article composed of a crosslinked polar ethylene-based polymer composition comprising (i) a polar ethylene-based polymer; and (ii) 2,2,6,6-tetramethyl-4-piperidyl methacrylate disulfide (BiTEMPS methacrylate);
forming, at the reprocessing temperature, the first article into a re-processable polar ethylene-based polymer composition;
shaping, at the reprocessing temperature, the re-processable polar ethylene-based composition into a re-processed pre-form; and
cooling the re-processed pre-form to below the reprocessing temperature and forming a second article composed of a re-crosslinked polar ethylene-based polymer composition composed of (i) the polar ethylene-based polymer and (ii) the BiTEMPS methacrylate, the second article different than the first article.
